(19) United States
(12) Patent Application Publication
(10) Pub. No.: US 2015/0302466 A1
(43) Pub. Date: Oct. 22, 2015

(54) DATA DETERMINATION METHOD AND DEVICE FOR A THERMODYNAMIC CHART

(71) Applicant: BEIJING GRIDSUM TECHNOLOGY CO., LTD., Beijing (CN)

(72) Inventors: Yongjian HUANG, Beijing (CN); Guosheng QI, Beijing (CN); Jibin YANG, Beijing (CN); Chong WU, Beijing (CN)

(73) Assignee: Beijing Gridsum Technology Co., Ltd., Beijing (CN)

(21) Appl. No.: 14/389,445

(22) PCT Filed: Oct. 12, 2012
(86) PCT No.: PCT/CN2012/082857

§ 371 Date: Sep. 30, 2014

(30) Foreign Application Priority Data
Aug. 17, 2012 (CN) 201210295639.8

(51) Int. Cl. G06Q 30/02

(52) U.S. Cl. CPC G06Q 30/0246; G06Q 30/0277

(57) ABSTRACT

The present disclosure discloses a method and a device for determining data in a thermodynamic chart. The method for determining data in a thermodynamic chart comprises: acquiring the thermodynamic chart of a webpage; acquiring a coordinate clicked by a user on the webpage and the data of an event, wherein the event is triggered by the click, and the data of the event is data corresponding to the event; and determining the data of the event corresponding to the coordinate in the thermodynamic chart. In the present disclosure, the data of an event corresponding to a point on the thermodynamic chart can be determined as each coordinate clicked by a user and the data of an event trigged by the click are acquired after the thermodynamic chart of a webpage is acquired, thus, the accuracy of a webpage data analysis is improved.

### TECHNICAL FIELD OF THE DISCLOSURE

The present disclosure relates to the field of Internet and in particular to a data determination method and device for a thermodynamic chart.

### BACKGROUND OF THE DISCLOSURE

Existing thermodynamic charts cannot meet the demands of webpage data analyzers, for example, if a user clicks, on a website, an interested image on which words ‘sales promotion’ are presented and to which no webpage link is set to direct to a corresponding webpage, then no response is made to the click of the user, thus, the user acquires no further message through the image, as a consequence, neither the access times nor the commercial value of the webpage is increased. However, as the image is clicked by a great many of users, it can be seen from the thermodynamic chart generated from the webpage that the click rate of the image is extremely high, and based on the thermodynamic chart, webpage data analyzers consider that the image is of high value to the webpage.

No effective solution has been proposed to address the problem existing in the prior art that the data of an event triggered by a position on a thermodynamic chart cannot be determined.

### SUMMARY OF THE DISCLOSURE

The present disclosure provides a data determination method and device for a thermodynamic chart to at least address the problem in the prior art that the data of an event triggered by a position on a thermodynamic chart cannot be determined.

To achieve the purpose above, in accordance with an aspect of the present disclosure, a data determination method for a thermodynamic chart is provided.

The data determination method for a thermodynamic chart provided herein comprises: acquiring the thermodynamic chart of a webpage; acquiring a coordinate clicked by a user on the webpage and the data of an event, wherein the event is triggered by the click, and the data of the event is data corresponding to the event; and determining the data of the event corresponding to the coordinate in the thermodynamic chart.

Further, acquiring a coordinate clicked by a user on the webpage and the data of an event comprises: acquiring a first user ID and a clicked coordinate when a first click is made by a user, wherein the first click triggers a first event, and the first user ID is the ID of the user making the first click; and acquiring the data of a second event and a second user ID, wherein the second event is triggered by a second click after the first event, the data of the second event is data corresponding to the second event, and the second user ID is the ID of the user making the second click; and determining the data of the event corresponding to the coordinate in the thermodynamic chart comprises: determining the data of the event corresponding to the coordinate in the thermodynamic chart, wherein it is determined that the coordinate of the first click corresponds to the data of the second event if the first user ID and the second user ID are the same.

Further, acquiring the data of a second event and a second user ID comprises: acquiring purchasing data and the second user ID if the user has a purchase behavior, wherein the purchasing data includes an order quantity and order information, and determining the data of the event corresponding to the coordinate in the thermodynamic chart comprises: determining the purchasing data corresponding to the coordinate in the thermodynamic chart.

Further, acquiring a first user ID and a clicked coordinate when a first click is made by a user comprises: acquiring the coordinate clicked, the first user ID and a first session ID, wherein the first session ID is the ID of a session corresponding to the first click, acquiring the data of a second event and a second user ID comprises: acquiring the data of the second event, a second user ID and a second session ID, wherein the second session ID is the ID of a session corresponding to the second click, and determining that the coordinate of the first click corresponds to the data of the second event if the first user ID and the second user ID are the same comprises: determining that the coordinate of the first click corresponds to the data of the second event if the first user ID and the second user ID are the same and the first session ID and the second session ID are the same.

Further, determining the data of the event corresponding to the coordinate in the thermodynamic chart comprises: determining the data of the event corresponding to the coordinate in the thermodynamic chart, the access times of a first user and the access times of a second user, wherein a user is determined as a first user when the ID of the user is acquired for the first time or a second user when the ID of the user is not acquired for the first time.

Further, determining the data of the event corresponding to the coordinate in the thermodynamic chart comprises: acquiring the coordinate arrange of a pre-selected area in the thermodynamic chart; and determining the data of an event corresponding to a coordinate in the coordinate range.

Further, a character string corresponding to the computer environment information of a user is acquired when the user accesses a webpage for the first time; the hash value the character string corresponds to in a hash function is acquired; a random number generated by a random number generator is acquired; and the hash value is combined with the random number to generate the ID of the user.

To achieve the purpose above, in accordance with another aspect of the present disclosure, there is provided a data determination device for a thermodynamic chart, which is used to realize an optional data determination method for a thermodynamic chart disclosed herein.

In accordance with another aspect of the present disclosure, there is provided a data determination device for a thermodynamic chart, which comprises: a first acquisition unit configured to acquire the thermodynamic chart of a webpage; a second acquisition unit configured to acquire a coordinate clicked by a user on the webpage and the data of an event, wherein the event is triggered by the click, and the data of the event is data corresponding to the event; and a determination unit configured to determine the data of the event corresponding to the coordinate in the thermodynamic chart.

Further, the second acquisition unit comprises: a first acquisition subunit configured to acquire a first user ID and a clicked coordinate when a first click is made by a user, wherein a first event is triggered by the first click, and the first user ID is the ID of the user making the first click; and a second acquisition subunit configured to acquire the data of a second event and a second user ID, wherein the second event is triggered by a second click after the first event, the data of the second event is data corresponding to the second event, and the second user ID is the ID of the user making the second click, and the determination unit is further configured to determine the data of the event corresponding to the coordinate in the thermodynamic chart, wherein it is determined that the coordinate of the first click corresponds to the data of the second event if the first user ID and the second user ID are the same.

Further, the second acquisition subunit is also configured to acquire purchasing data if the user has a purchase behavior and a second user ID, wherein the purchasing data includes an order quantity and order information, and the determination unit is further configured to determine the purchasing data corresponding to the coordinate in the thermodynamic chart.

Further, the first acquisition subunit is also configured to acquire a coordinate clicked, the first user ID and a first session ID, wherein the first session ID is the ID of a session corresponding to the first click, the second acquisition subunit is also configured to acquire the data of the second event, the second user ID and a second session ID, wherein the second session ID is the ID of a session corresponding to the second click, wherein it is determined that the coordinate of the first click corresponds to the data of the second event if the first user ID and the second user ID are the same and the first session ID and the second session ID are the same.

Further, the determination unit is also configured to determine the data of the event corresponding to the coordinate in the thermodynamic chart, the access times of a first user and the access times of a second user, wherein a user is determined as a first user when the ID of the user is acquired for the first time or a second user when the ID of the user is not acquired for the first time.

Further, the determination unit comprises: a third acquisition subunit configured to acquire the coordinate range of a pre-selected area in the thermodynamic chart; and a determination subunit configured to determine the data of an event corresponding to a coordinate in the coordinate range.

The present disclosure, in which the data of an event corresponding to a point on the thermodynamic chart can be determined as each coordinate clicked by a user and the data of an event trigged by the click are acquired after the thermodynamic chart of a webpage is acquired, addresses the problem in the prior art that the data of an event triggered by a position on the thermodynamic chart cannot be determined and therefore improves the accuracy of a webpage data analysis.

### BRIEF DESCRIPTION OF THE DRAWINGS

The accompanying drawings described here are provided for a better understanding of the present disclosure and form one part of the present disclosure, and exemplary embodiments of the present disclosure and the description thereof are illustrative of the present disclosure but are not to be construed as limiting the present disclosure. In the accompanying drawings:

FIG. 1 is a block diagram illustrating the structure of a data determination device for a thermodynamic chart according to an embodiment of the present disclosure;

FIG. 2 is a block diagram illustrating the structure of a data determination device for a thermodynamic chart according to a first preferred embodiment of the present disclosure;

FIG. 3 is a flowchart illustrating a data determination method for a thermodynamic chart according to an embodiment of the present disclosure;

FIG. 4 is a flowchart illustrating a data determination method for a thermodynamic chart according to a preferred embodiment of the present disclosure; and

FIG. 5 is a schematic diagram illustrating a data analysis method for a thermodynamic chart according to a preferred embodiment of the present disclosure.

### DETAILED DESCRIPTION OF THE EMBODIMENTS

It should be noted that embodiments described herein and features thereof can be combined with each other if no conflict is caused. The present disclosure is described below in detail with reference to accompanying drawings when read in conjunction with embodiments.

A data determination device for a thermodynamic chart provided in an embodiment of the present disclosure is described below.

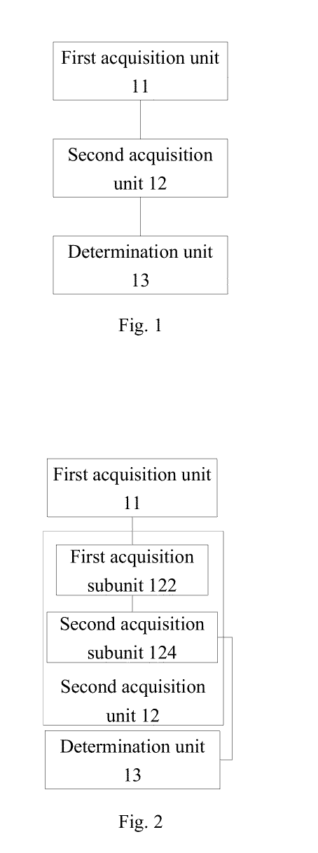

FIG. 1 is a block diagram illustrating the structure of a data determination device for a thermodynamic chart according to an embodiment of the present disclosure.

As shown in FIG. 1, the data determination device for a thermodynamic chart comprises a first acquisition unit 11, a second acquisition unit 12 and a determination unit 13.

The first acquisition unit 11 acquires the thermodynamic chart of a webpage.

In a thermodynamic chart, the number of the clicks on a point of the webpage is distinguished through the shade of a color, and an area of a deeper color indicates a higher number of clicks. The first acquisition unit 11 may acquire the thermodynamic chart of a webpage to lay a foundation for a later data analysis.

The second acquisition unit 12 acquires a coordinate clicked by a user on the webpage and the data of an event, wherein the event is an event triggered by the click, and the data of the event is data corresponding to the event.

The determination unit 13 determines the data of the event corresponding to the coordinate in the thermodynamic chart.

In a specific embodiment, the second acquisition unit 12 may acquire a coordinate and a link address clicked by a user, and the determination unit 13 determines the relationship between the link address and the coordinate, and the link address of a point on the thermodynamic chart can be acquired by a data analyzer who desires to acquire corresponding data of the point, in this way, an image for which no link is set is optimized.

In the embodiment, as each coordinate clicked by a user and the data of the event triggered by the click are acquired after the thermodynamic chart of a webpage is acquired, the data of an event corresponding to a point on the thermodynamic chart can be determined, thus, the present disclosure addresses the problem in the prior art that the data of an event triggered by a position on a thermodynamic chart cannot be determined and therefore improves the accuracy of a webpage data analysis.

FIG. 2 is a block diagram illustrating the structure of a data determination device for a thermodynamic chart according to a preferred embodiment of the present disclosure. The preferred embodiment may be a preferred implementation mode of the embodiment shown in FIG. 1.

As shown in FIG. 2, the data determination device for a thermodynamic chart comprises a first acquisition unit 11, a second acquisition unit 12 and a determination unit 13, wherein the second acquisition unit 12 comprises a first acquisition subunit 122 and a second acquisition subunit 124.

The first acquisition subunit 122 acquires a first user ID and a clicked coordinate when a user makes a first click, wherein the first click triggers a first event, and the first user ID is the ID of the user making the first click.

The second acquisition subunit 124 acquires the data of a second event and a second user ID, wherein a second click triggers the second event after the first event, the data of the second event is data corresponding to the second event, and the second user ID is the ID of the user making the second click.

In the embodiment, the determination unit 13 further determines the data of an event corresponding to a coordinate in the thermodynamic chart, wherein it is determined that the coordinate of the first click corresponds to the data of the second event if the first user ID and the second user ID are the same.

In the embodiment, the coordinate of the first click is correlated with the event triggered by the second click so that a data analyzer can analyze the relationship between the coordinate of the first click and the event triggered by the second event to improve the accuracy of data analysis.

When the second click triggers a purchase behavior, the second acquisition subunit 124 further acquires purchasing data and the second user ID if the user has a purchase behavior, wherein the purchasing data includes an order quantity and order information, and accordingly, the determination unit 13 further determines the purchasing data corresponding to the coordinate in the thermodynamic chart.

To reduce the quantity of the data to be analyzed, data is analyzed in sessions in the embodiment, and preferably, the first acquisition subunit 122 further acquires a clicked coordinate, the first user ID and a first session ID, wherein the first session ID is the ID of a session corresponding to the first click. Accordingly, the second acquisition subunit 124 further acquires the data of the second event, the second user ID and a second session ID, wherein the second session ID is the ID of a session corresponding to the second click, and it is determined that the coordinate acquired from the first click corresponds to the data of the second event if the first user ID and the second user ID are the same and the first session ID and the second session ID are the same.

To acquire data of new visitors and old visitors, preferably, the determination unit 13 further determines the data of an event corresponding to a coordinate in the thermodynamic chart, the access times of a first user and the access times of a second user, wherein a user is determined as a first user when the ID of the user is acquired for the first time or a second user when the ID of the user is not acquired for the first time.

A data analysis may be conducted for not only each point but also a certain range in the embodiment, preferably, the determination unit 13 comprises: a third acquisition subunit configured to acquire the coordinate range of a pre-selected area in the thermodynamic chart. And a determination subunit configured to determine the data of an event corresponding to a coordinate in the coordinate range.

A data determination method for a thermodynamic chart provided in an embodiment of the present disclosure is realized by the foregoing data determination device for a thermodynamic chart.

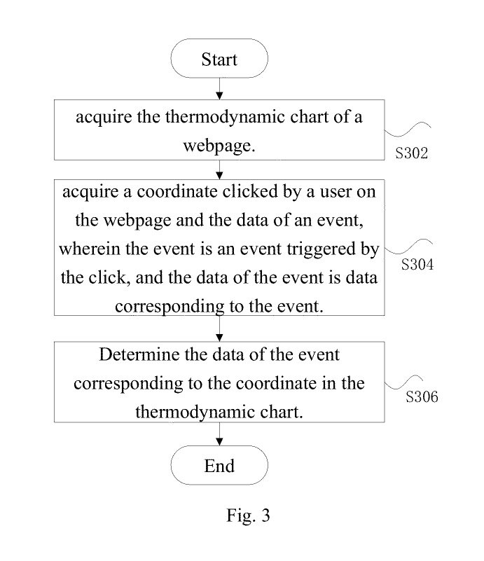

FIG. 3 is a flowchart illustrating a data determination method for a thermodynamic chart according to an embodiment of the present disclosure.

As shown in FIG. 3, the data determination method for a thermodynamic chart comprises the following steps S302-S306.

Step S302: acquire the thermodynamic chart of a webpage.

Step S304: acquire a coordinate clicked by a user on the webpage and the data of an event, wherein the event is an event triggered by the click, and the data of the event is data corresponding to the event.

Step S306: determine the data of the event corresponding to the coordinate in the thermodynamic chart.

Considering the problem existing in the prior art, in the embodiment, the thermodynamic chart of a webpage is acquired first, then a coordinate clicked by a user on the webpage and a link address set at the clicked position are acquired, thereby determining the correspondence relationship between the coordinate on the thermodynamic chart and the link, thus, whether or not a link is set for a point on the thermodynamic chart of the webpage and the link address of each link can be known during a network data analysis. In the embodiment, an image on a webpage which is clicked frequently and for which no link is set can be found, thus, a targeted optimization can be conducted for the webpage.

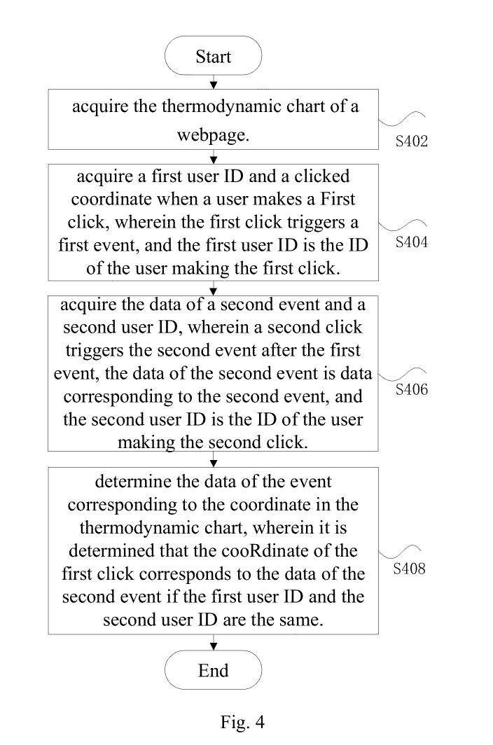

FIG. 4 is a flowchart illustrating a data determination method for a thermodynamic chart according to a preferred embodiment of the present disclosure.

As shown in FIG. 4, a data determination method for a thermodynamic chart comprises the following steps S402-S408 in which steps S302-S306 are described in detail.

Step S402: acquire the thermodynamic chart of a webpage.

Step S404: acquire a first user ID and a clicked coordinate when a user makes a first click, wherein the first click triggers a first event, and the first user ID is the ID of the user making the first click.

The user ID of a user clicked on a webpage and the coordinate (X, Y) of the clicked position are stored by the Webdissector script in the webpage, and as user IDs are also stored in the following steps, the user ID stored in Step S404 is referred to as a first user ID in the embodiment. In analyzing data, a network data analyzer needs to pay attention to the outcome of each click, and a click operation generally triggers a corresponding event, for example, a click generally leads to the redirection to a new webpage, and the redirection is referred to as a first event.

Step S406: acquire the data of a second event and a second user ID, wherein a second click triggers the second event after the first event, the data of the second event is data corresponding to the second event, and the second user ID is the ID of the user making the second click.

The user may click on the redirected webpage to accomplish a specific user behavior such as an on-line shopping behavior, a registration behavior or a download behavior, the relevant data of which generally gets much attention from a website producer and a data analyzer, if the website producer and the data analyzer pay attention to a purchase behavior, the website producer and the data analyzer focus on an order quantity and order information, including a user ID, an order number, an order quantity, an order amount and the product purchased; if the website producer and the data analyzer pay attention to a registration behavior, the website producer and the data analyzer focus on a user ID, a registration name and a registration quantity; and if the website producer and the data analyzer pay attention to a download behavior, the website producer and the data analyzer focus on a user ID, the content downloaded and a download times. To facilitate the understanding of the present disclosure, a purchase behavior is exemplarily described in the embodiment.

Specifically, in the embodiment, purchasing data and a second user ID are acquired when a user has a purchase behavior, wherein the purchasing data includes an order quantity and order information.

Step S408: determine the data of the event corresponding to the coordinate in the thermodynamic chart, wherein it is determined that the coordinate of the first click corresponds to the data of the second event if the first user ID and the second user ID are the same.

Specifically, it is determined the purchasing data corresponds to the coordinate in the thermodynamic chart in Step S408 in the embodiment.

After being acquired in the foregoing steps, the data mentioned in the foregoing steps may be correlated with the other acquired data according to the user ID, that is, the user ID plays the role of a bridge, both the coordinate relevant to the user ID and the order quantity and the order information relevant to the user ID can be acquired through the user ID. Then, the data analyzer can know how many orders are generated at a certain position on the webpage and the order information of each order.

To analyze the access times of new users and old users, preferably, the data of an event corresponding to a coordinate in the thermodynamic chart, the access times of a first user and the access times of a second user may be determined in the embodiment, wherein a user is determined as a first user when the ID of the user is acquired for the first time or a second user when the ID of the user is not acquired for the first time.

To address the problem that all the information of a user ID needs to be called for each data analysis, in the embodiment, a user ID is acquired every time along with a session ID, and generally, the process from the opening of a browser to the closing of the browser is considered as a session, and a purchase behavior, a registration behavior or a download behavior is conducted in a session, thus, a data statistics is conducted in sessions, which guarantees the accuracy of a data analysis while reducing the quantity of the data called and consequentially reduces the load of the hardware during a data analysis and increases the speed of the data analysis.

In the embodiment, when a user accesses a webpage needing a data analysis for the first time, session data and the pageview data of the first access are acquired, wherein the pageview data of the first access contains the webpage data of the first webpage viewed by the user, meanwhile, a user ID and a session ID are generated by the website when the user accesses the first accessed webpage. Webdissector adopts a Cookie technology as a means for distinguishing different users. A Cookie carrying a unique identification string identifying a user identity, that is, a user ID and a session ID, is implanted to the browser of a user by Webdissector codes once the user accesses a webpage set with the Webdissector codes so that the user ID and the session ID are stored. When the user accesses the website next time, the user can be recognized by the Webdissector codes as an old user, and no new user ID is generated.

Sometimes, a data analyzer pays more attention to the set of the data of all the positions in a certain range, for example, the data of all the positions on a picture, during a data analysis for a webpage, in this case, the data of a certain area framed by a data analyzer is further determined in Step S408, and in the embodiment, the area framed by a data analyzer is a pre-selected area, thus, Step 408 may specifically comprise the following two steps:

Firstly, acquire the coordinate range of the pre-selected area in the thermodynamic chart.

Secondly, determine the data of an event corresponding to a coordinate in the coordinate range.

A coordinate range can be determined after an area is framed, and all the data within the coordinate range can be acquired from a database, thus, how many different user IDs and session IDs and how many different users access the webpage can be acquired from the data; besides, how many orders, that is, how many times of purchase behaviors occur, can be extracted from the data. For example, if an optional area is framed on a webpage and then a symbol ‘+’ is clicked, then how many users clicked this area and how many orders are generated in this area can be mastered, which facilitates an analysis.

To guarantee the uniqueness of a user ID and a session ID, a method for generating a user ID and a session ID is further improved, which comprises, in the embodiment, acquiring a character string corresponding to the computer environment information of a user when the user accesses a webpage for the first time, acquiring the hash value the character string corresponds to in a hash function, acquiring a random number generated by a random number generator, and combining the hash value with the random number to generate a user ID and a session ID, combining a user ID and a session ID using by different methods to guarantee the difference between the user ID and the session ID.

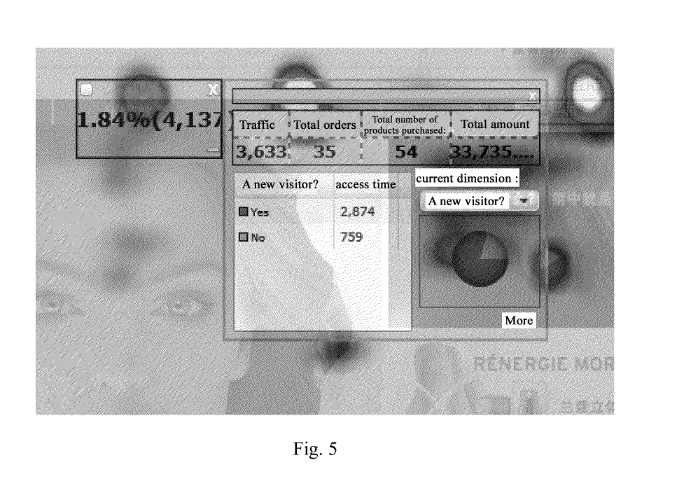

FIG. 5 is a schematic diagram illustrating a method for analyzing data in a thermodynamic chart according to a preferred embodiment of the present disclosure. As shown in FIG. 5, according to the embodiment, after a certain area is framed on a thermodynamic chart, the clicks of the area, the proportion of the clicks of the area to the clicks of the whole webpage, an order quantity, a purchase quantity, a purchase value and the access times of new and old visitors may be displayed on the thermodynamic chart.

As the data in a thermodynamic chart is correlated with a following user behavior, the accuracy of the data analysis on user behaviors is increased in the embodiment.

It should be noted that the steps shown in the flowchart of the accompanying drawings may be executed in, for example, a computer system in which instructions can be executed by a computer, moreover, although a logic sequence is shown in the flowchart, the shown or described steps may be executed in a different sequence in some cases.

Apparently, it should be understood by those skilled in the art that each aforementioned module or step of the present disclosure can be realized by a universal computer, centralized on a single computer or distributed on a network consisting of a plurality of computers, or alternatively realized by computer-executable program codes, the modules or steps can be therefore stored in a memory device to be executed by a computer, alternatively, the modules or steps are manufactured into integrated circuit modules, or some of the modules or steps are manufactured into a single integrated circuit module. Thus, the present disclosure is not limited to any special combination of hardware and software.

The mentioned above is merely preferred embodiments of the present invention but is not limitation to the present invention, various modification and variations can be devised by those skilled in the art. It should be understood that any modification, equivalent and improvement devised without departing from the spirit and scope of the present invention falls within the protection scope of the present invention.

What is claimed is:

1. A data determination method for a thermodynamic chart, comprising:
acquiring a thermodynamic chart of a webpage;
acquiring a coordinate clicked by a user on the webpage and data of an event, wherein the event is triggered by the click, and the data of the event is data corresponding to the event; and
determining the data of the event corresponding to the coordinate in the thermodynamic chart.

2. The data determination method for a thermodynamic chart according to claim 1, wherein
acquiring a coordinate clicked by a user and the data of an event comprises:
acquiring a first user ID and a clicked coordinate when a first click is made by a user, wherein the first click triggers a first event, and the first user ID is the ID of the user making the first click; and
acquiring the data of a second event and a second user ID, wherein the second event is triggered by a second click after the first event, the data of the second event is data corresponding to the second event, and the second user ID is the ID of the user making the second click; and
determining the data of the event corresponding to the coordinate in the thermodynamic chart comprises:
determining the data of the event corresponding to the coordinate in the thermodynamic chart, wherein it is determined that the coordinate of the first click corresponds to the data of the second event if the first user ID and the second user ID are the same.

3. The data determination method for a thermodynamic chart according to claim 2, wherein
acquiring the data of a second event and a second user ID comprises:
acquiring purchasing data and the second user ID if the user has a purchase behavior, wherein the purchasing data includes an order quantity and order information; and
determining the data of the event corresponding to the coordinate in the thermodynamic chart comprises:
determining the purchasing data corresponding to the coordinate in the thermodynamic chart.

4. The data determination method for a thermodynamic chart according to claim 2, wherein
acquiring a first user ID and a clicked coordinate when a first click is made by a user comprises: acquiring the coordinate clicked, the first user ID and a first session ID, wherein the first session ID is the ID of a session corresponding to the first click;
acquiring the data of a second event and a second user ID comprises:
acquiring the data of the second event, a second user ID and a second session ID, wherein the second session ID is the ID of a session corresponding to the second click; and
determining that the coordinate of the first click corresponds to the data of the second event if the first user ID and the second user ID are the same comprises:
determining that the coordinate of the first click corresponds to the data of the second event if the first user ID and the second user ID are the same and the first session ID and the second session ID are the same.

5. The data determination method for a thermodynamic chart according to claim 2, wherein determining the data of the event corresponding to the coordinate in the thermodynamic chart comprises:
determining the data of the event corresponding to the coordinate in the thermodynamic chart, the access times of a first user and the access times of a second user, wherein a user is determined as a first user when the ID of the user is acquired for the first time or a second user when the ID of the user is not acquired for the first time.

6. The data determination method for a thermodynamic chart according to claim 1, wherein determining the data of the event corresponding to the coordinate in the thermodynamic chart comprises:
acquiring the coordinate arrange of a pre-selected area in the thermodynamic chart; and
determining the data of an event corresponding to a coordinate in the coordinate range.

7. The data determination method for a thermodynamic chart according to claim 1, wherein
a character string corresponding to the computer environment information of a user is acquired when the user accesses a webpage for the first time;
the hash value the character string corresponds to in a hash function is acquired;
a random number generated by a random number generator is acquired; and
the hash value is combined with the random number to generate the ID of the user.

8. A data determination device for a thermodynamic chart, comprising:
a first acquisition unit configured to acquire a thermodynamic chart of a webpage;
a second acquisition unit configured to acquire a coordinate clicked by a user on the webpage and data of an event, wherein the event is triggered by the click, and the data of the event is data corresponding to the event; and
a determination unit configured to determine data of the event corresponding to the coordinate in the thermodynamic chart.

9. The data determination device for a thermodynamic chart according to claim 8, wherein
the second acquisition unit comprises:
a first acquisition subunit configured to acquire a first user ID and a clicked coordinate when a first click is made by a user, wherein a first event is triggered by the first click, and the first user ID is the ID of the user making the first click; and
a second acquisition subunit configured to acquire the data of a second event and a second user ID, wherein the second event is triggered by a second click after the first event, the data of the second event is data corresponding to the second event, and the second user ID is the ID of the user making the second click; and
the determination unit is further configured to determine the data of the event corresponding to the coordinate in the thermodynamic chart, wherein it is determined that the coordinate of the first click corresponds to the data of the second event if the first user ID and the second user ID are the same.

10. The data determination device for a thermodynamic chart according to claim 9, wherein
the second acquisition subunit is also configured to acquire purchasing data if the user has a purchase behavior and a second user ID, wherein the purchasing data includes an order quantity and order information, and
the determination unit is further configured to determine the purchasing data corresponding to the coordinate in the thermodynamic chart.

11. The data determination device for a thermodynamic chart according to claim 9, wherein
the first acquisition subunit is also configured to acquire a coordinate clicked, the first user ID and a first session ID, wherein the first session ID is the ID of a session corresponding to the first click; and
the second acquisition subunit is also configured to acquire the data of the second event, the second user ID and a second session ID, wherein the second session ID is the ID of a session corresponding to the second click, wherein it is determined that the coordinate of the first click corresponds to the data of the second event if the first user ID and the second user ID are the same and the first session ID and the second session ID are the same.

12. The data determination device for a thermodynamic chart according to claim 9, wherein
the determination unit is configured to determine the data of the event corresponding to the coordinate in the thermodynamic chart, the access times of a first user and the access times of a second user, wherein a user is determined as a first user when the ID of the user is acquired for the first time or a second user when the ID of the user is not acquired for the first time.

13. The data determination device for a thermodynamic chart according to claim 8, wherein the determination unit comprises:
a third acquisition subunit configured to acquire the coordinate range of a pre-selected area in the thermodynamic chart; and
a determination subunit configured to determine the data of an event corresponding to a coordinate in the coordinate range.
